(19) United States
(12) Patent Application Publication
(10) Pub. No.: US 2009/0067699 A1
(43) Pub. Date: Mar. 12, 2009

(54) OPTIMIZATION OF VELOCITY SCALE FOR COLOR TISSUE DOPPLER IMAGING

(75) Inventor: David W. Clark, Windham, NH (US)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS, N.V., EINDHOVEN (NL)

(21) Appl. No.: 12/282,659

(22) PCT Filed: Mar. 14, 2007
(86) PCT No.: PCT/IB07/50869

§ 371 Date: Sep. 12, 2008

(30) Foreign Application Priority Data
Mar. 14, 2007 (IB) PCT/IB2007/050869

(51) Int. Cl. G06K 9/00

(52) U.S. Cl. 382/131

(57) ABSTRACT

An ultrasonic diagnostic imaging system is operable to produce tissue Doppler images and data for diagnostic use. The system includes a visual or audible alert which alerts a user to the possibility of aliasing in the tissue Doppler image data and the need to reset the velocity scale of the color map. The visual alert may be a light on the display screen or control panel or contrasting colors to the colors of the color map in an area of the image where aliasing may be occurring. The visual alert may be a histogram displayed in alignment with the color bar of the tissue Doppler image. The indication by the histogram of image values at a velocity limit of the color bar indicates a need to adjust the color velocity scaling.

This invention relates to medical diagnostic ultrasound systems and, in particular, to ultrasound systems for which the velocity scale for color tissue Doppler imaging can be optimized.

Tissue Doppler ultrasound is used in echocardiography to measure the motion and timing of the myocardium. Tissue Doppler ultrasound is an adaptation of the ultrasound techniques used for analyzing blood velocity: color flow mapping, and spectral and audio pulsed-wave Doppler. This invention relates to color tissue Doppler imaging (TDI) in which a quantification of the motion of moving tissue such as velocity or acceleration is displayed in an identifying color in the tissue image. In the blood flow techniques, a clutter filter rejects the strong, slow tissue echo so that the very weak, faster blood echo can be seen. Tissue Doppler typically does not use a clutter filter, and the slow tissue echo that is analyzed is the dominant signal, generally far above the amplitude of blood, noise, and reverberation signals. The main use for color TDI is analysis of velocity, strain rate, and strain, which compare the timing of different sections of the myocardium with time-domain graphs derived from a stored sequence (loop) of images. The color TDI frame rate is preferably at least 90 Hz so that these graphs have adequate time resolution. A diagnosis is generally never made from live color TDI, but during review of the stored sequence.

During live color TDI operation when the sequence for analysis is acquired, the user should ensure that the velocity scale for color assignment is set optimally so that the heart motion uses most of the scale range, but without exceeding the range. If the scale is set too high, the color data will have poor velocity resolution, which implies poor velocity resolution in the derived graphs. If the scale is set too low, the velocity can alias to the opposite direction, which produces garbled derived graphs. It is possible to develop analysis algorithms that unwrap aliasing, but current strain timing software does not utilize such algorithms.

The only purpose of the colors in the live color TDI display is to help the user set the velocity scale and to reassure the user that velocity data actually is being acquired. Users typically like to see fairly uniform red or blue in TDI, depending on the motion direction. However, the live color TDI frame rate is usually faster than a human can perceive, and the live images often rapidly flash between red and blue. In these circumstances, it can be difficult to visually perceive aliasing, and the user may be using a non-optimal velocity scale.

Some color maps have a smooth variation of color from zero to plus/minus full scale velocity, such as red to yellow, and blue to green. This makes velocities in the top half of the color range appear distinctly different than colors assigned to lower velocities. However, when using such maps, TDI practitioners tend to increase the scale so that the TDI images only contain red and blue, which is too high a scale for optimal resolution. Accordingly it is desirable to assist the user in acquiring useful TDI data which is not subject to aliasing artifacts, while still accommodating the use of the preferred red and blue color maps.

In accordance with the principles of the present invention, a diagnostic ultrasound system alerts the user when aliasing or inadequate use of the velocity display range occurs during color tissue Doppler imaging operation. The alert can be an audible or visual alert, notifying the user to the use of an inadequate velocity scale. A visual indicator can indicate the proportion of the present velocity scale actually being used, for instance. In response to the alert the user can set the velocity scale to a more optimal range or the system can automatically optimize the scale.

### IN THE DRAWINGS

FIG. 1 illustrates in block diagram form an ultrasonic diagnostic imaging system constructed in accordance with the principles of the present invention.

FIG. 2 is a screen shot of a color tissue Doppler image of the heart and its corresponding color bar.

FIG. 3 illustrates the screen of an ultrasound system of the present invention which shows a histogram of color bar utilization.

FIG. 4 illustrates the screen of an ultrasound system of the present invention which shows a histogram indicating an inadequate velocity scale.

FIG. 5 illustrates another screen of an ultrasound system of the present invention with two histograms of color bar utilization.

FIG. 6 illustrates in block diagram form another ultrasonic diagnostic imaging system constructed in accordance with the principles of the present invention for automatic velocity scale optimization.

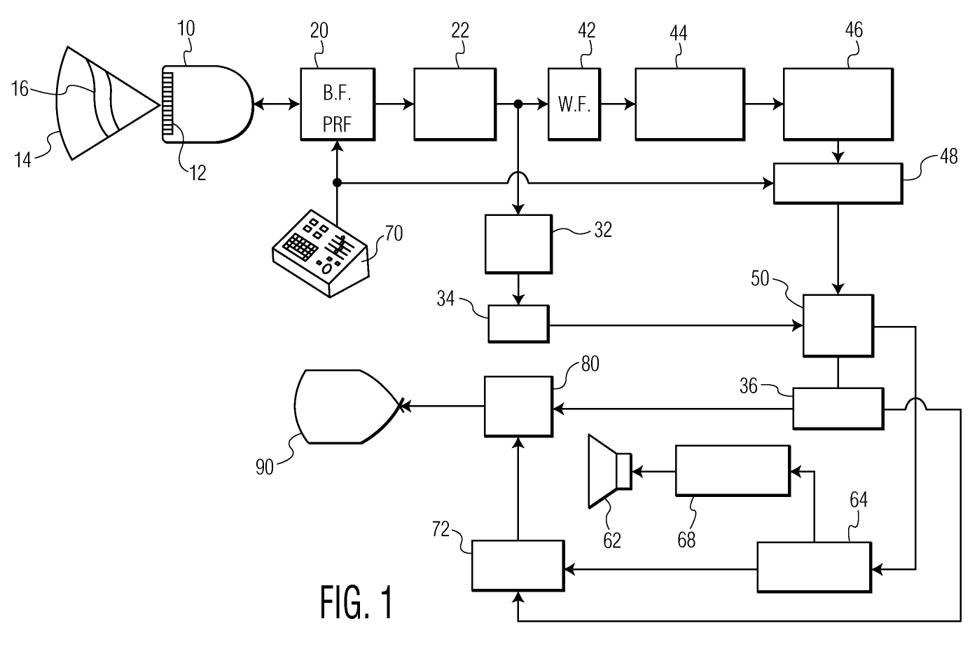

Referring first to FIG. 1, an ultrasonic diagnostic imaging system constructed in accordance with the principles of the present invention is shown in block diagram form. An ultrasonic probe 10 has an array transducer 12 which transmits ultrasonic waves over an image field 14 in the body. In this illustration the image field 14 is shown as sector-shaped as would be scanned by a phased array transducer. The illustrated sector image includes a blood vessel or other organ 16 which is being interrogated by the probe. In the examples shown below the heart is being imaged. If a two dimensional image plane is to be scanned the array will comprise a one-dimensional array of transducer elements, and if elevation focusing is used or a three dimensional volume is to be scanned in real time, the array will comprise a two-dimensional array of elements. Echoes from the transmitted waves are received by the array transducer, converted into electrical signals, and coupled to a beamformer 20. In the beamformer the signals from the elements of the array transducer are delayed and combined to form steered and focused beams of sequences of echo signals from depth locations along the beam directions. The echo signals are coupled to an I,Q demodulator 22 which detects quadrature components of the echo signals.

The quadrature signal components can be processed in two signal paths: a B mode signal path and a Doppler signal path. In the B mode signal path the I,Q signals undergo detection by an amplitude detector 32. The detected signal are logarithmically compressed by a log compressor 34 and are coupled to a scan converter 50, which smoothes the image information and converts the image signals to the desired image format, which is a sector shape in this example. In the Doppler signal path the I,Q signals are filtered by a wall filter 42 to remove any unwanted signals such as tissue signals when flow is being imaged. For tissue Doppler imaging the wall filter may be bypassed or set to pass all Doppler signals or programmed as a lowpass filter to pass tissue echo signals to the exclusion of the higher velocity blood flow signals. The Doppler shift is then estimated by a Doppler processor 44. A preferred Doppler estimator is an auto-correlator, in which velocity (Doppler frequency) estimation is based on the argument of the lag-one autocorrelation function and Doppler power estimation is based on the magnitude of the lag-zero autocorrelation function. Motion can also be estimated by known phase-domain (for example, parametric frequency estimators such as MUSIC, ESPRIT, etc.) or time-domain (for example, cross-correlation) signal processing techniques. Other estimators related to the temporal or spatial distributions of velocity such as estimators of acceleration or temporal and/or spatial velocity derivatives can be used instead of or in addition to velocity estimators. The velocity estimates undergo threshold detection to reduce noise, segmentation and post-processing such as hole filling and smoothing in a post-processor 46. The velocity estimates are applied to a quantization processor 48 which determines the range or scale of the velocity values to be quantized to the color display range, typically 8 bits covering the ±PRF/2 range. The quantized velocity estimates are applied to the scan converter 50 where they are converted to the desired image format, matching that of the B mode image on which they are displayed. The scan converted B mode and velocity values are coupled to a mapping processor 36 which maps the values to the desired ranges of gray and color for the two overlaid displays. The range of display colors used in the color Doppler image, referred to herein as the velocity scale or color bar, is coupled to a graphics processor 72 which displays the color bar alongside the color Doppler image.

The color Doppler images are coupled to a video processor 80 which displays the real time images on a display screen 90. In a tissue Doppler imaging exam the TDI images are also applied to a Cineloop® buffer (not shown), which stores the most recent sequence of acquired images. The number of images stored in the Cineloop buffer depends upon the size of the storage device used. A sequence of TDI images can be saved in the Cineloop buffer for later graphical analysis and diagnosis as described above, or a longer duration of TDI images can be recorded on videotape or by a digital video recorder for later analysis.

In accordance with the principles of the present invention, the velocities which are mapped to display colors by the color mapping process are coupled to a histogram processor 64. The histogram processor effectively counts the number of times each color value in the velocity scale is used in a tissue Doppler image. This may be done by the use of bins corresponding to the range of values of the color velocity scale of the color bar, with the count of a bin incremented each time an image point uses the velocity value to which that bin corresponds. While the histogram processor is capable of producing a histogram of velocity values for each image frame, this rate of display will usually be too high for practical use. Instead of updating a histogram display each frame, the display is preferably updated periodically, such as once each cardiac cycle or once each ten seconds, or at some other periodic interval. The timing of the cardiac cycle is available from the patient ECG signal monitored by the echocardiography system. A histogram which is to be displayed is coupled to the graphics processor 72 and the video processor displays the histogram in conjunction with the color bar of the tissue Doppler images.

The histogram processor 64 is also coupled to an audio processor 68 which produces an audible tone through a speaker 62 when aliasing occurs. Aliasing can be identified by the filling of histogram bins adjacent to the upper or lower terminus of the color bar. For instance, the presence of a significant number of tissue motion color values within ±3% of an end of the scale where aliasing wraps (generally ±PRF/2) can be taken to be an indication that aliasing is present or likely to occur. When this condition is detected the audio processor issues an audible alert through the speaker 62. Alternatively an anti-aliasing algorithm can detect the onset of aliasing and trigger the audible alert.

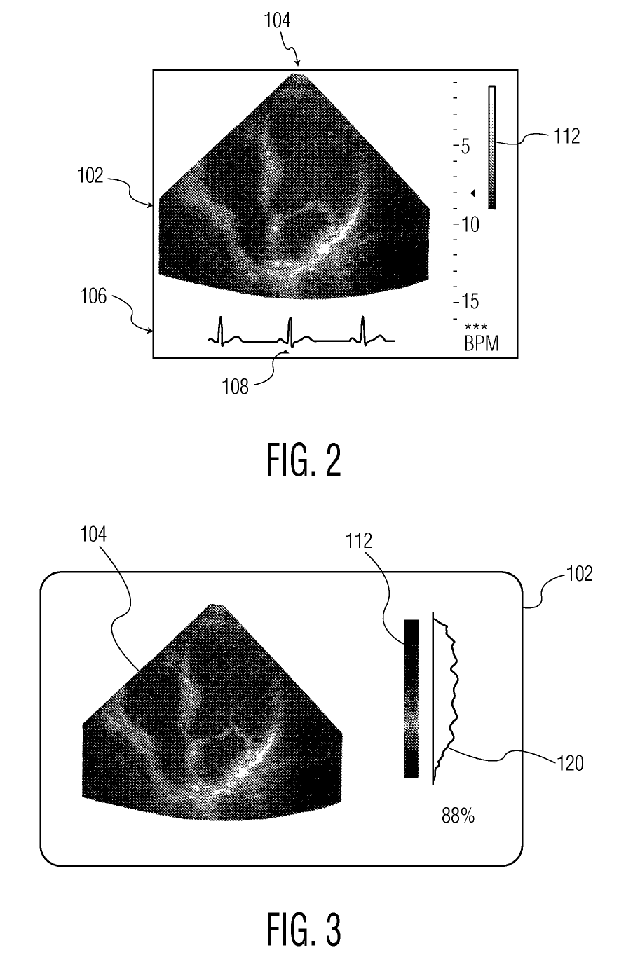

FIG. 2 illustrates the display screen 102 of an ultrasound system of the present invention when conducting tissue Doppler imaging. The arrow 104 is pointing at a four chamber tissue Doppler image of the heart, in this case, a four chamber view. As is customary during echocardiography exams, the patient's ECG is monitored and displayed at the bottom of the screen 106. A marker 108 indicates the point in the cardiac cycle when the image on the screen was acquired.

To the right of the image in this screen shot is a depth scale, and to the right of the depth scale is a color bar 112. The color bar illustrates the range of velocity-corresponding colors used to depict tissue motion in the tissue Doppler image 104. The color bar is frequently accompanied by numerical indicators of the color velocity scale, such as +5 cm/sec at the top of the color bar and −5 cm/sec at the bottom. The colors give the user a sense of the velocities of different areas of the heart anatomy and highlight regions of the anatomy where higher and lower velocities of tissue movement are occurring. In accordance with the principles of the present invention, regions of the anatomy where aliasing is occurring or likely to occur is highlighted in a distinguishing color. For instance, as previously explained, the typical TDI user will set the color bar to be a range of reds and blues. But when a velocity value nears or exceeds and endpoint of the velocity range, such as within 3% of a range terminus, those velocity values are displayed on the TDI image, not as red or blue, but as a distinguishing color such as yellow or green. While the distinguishing color may not appear on the image for long (although it could be persisted as described in U.S. Pat. No. 5,215,094), the difference in color is likely to be perceptible to the user even if it only flashes on the screen momentarily. Thus, the user is alerted to an aliasing situation and can reset the quantization range of the velocity values used by the color bar to a greater range (e.g., ±10 cm/sec) with the velocity scale control. The user can also adjust the PRF (pulse repetition frequency) of the color ensembles. Alternatively or additionally, a message “Aliasing!” could be flashed on the display screen in this situation, or a light actuated on the control panel 70 next to the velocity scale on the control panel. Any of these alerts will indicate to the user that action is recommended for the acquisition of diagnostically useful TDI data.

FIG. 3 illustrates another screen shot 102 of an ultrasound system of the present invention. A histogram 120 produced by the histogram processor 64 is displayed adjacent to the color bar 112 in this example. The histogram is a curve or series of points indicating the number of pixels in the color tissue Doppler image 104 used by each color of the color bar. The excursion of the histogram curve 120 to the right of its straight line baseline provides this indication: the greater the excursion, the greater the number of pixels of the color at that level of the curve. In this example the histogram 120 is indicating a fairly uniform distribution of values between the endpoints (top and bottom) of the color bar, with few or no pixels (velocities) at the endpoints. The percentage number below the histogram shows that 88% of the color bar is being used significantly in the TDI image 104. Thus, the user is informed both graphically and numerically that the velocity scale of the color bar 112 is appropriate for the tissue velocities which are present for this patient.

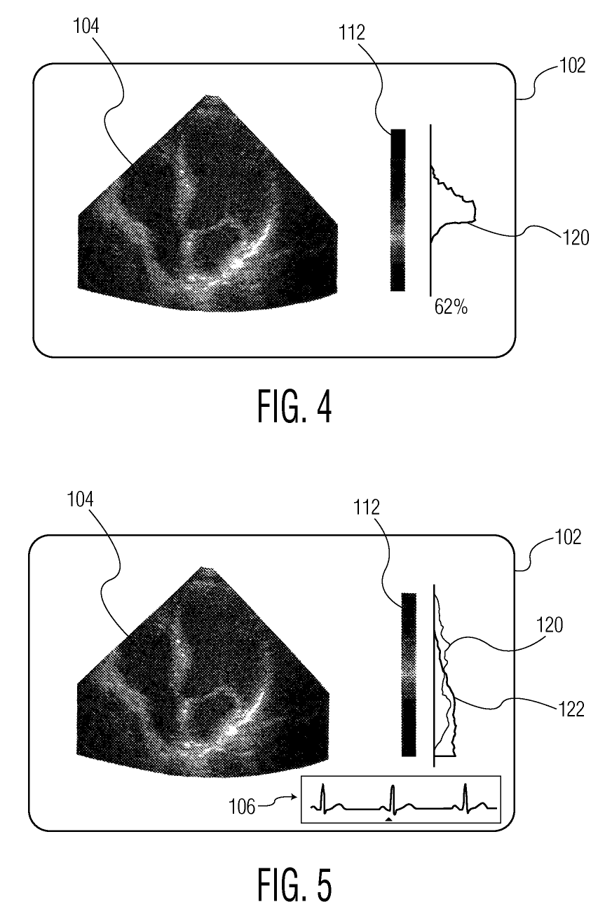

FIG. 4 illustrates a screen shot 102 when the full range of the velocity range of the color bar 112 is being used inadequately. In this case the histogram 120 shows a concentration of pixel numbers in the center of the color bar. The numerical indicator shows the user that only 62% of the range of the color bar is being used significantly. These two indicators would inform the user that adjustment of the velocity scale is recommended to make better use of the full color display range. In the example of FIG. 1 the user can use the control panel to adjust the quantization scale of the velocity estimates, quantizing a different range of velocity estimates to the color display range. Alternatively the user can adjust the pulse repetition frequency (PRF) of the transmitted Doppler ensembles to effect a broader frequency range during acquisition.

FIG. 5 is another example of the present invention in which a double histogram curve 102,122 is displayed. The two histogram curves are produced on temporally different bases. In this example the darker curve 122 presents histogram data over a longer term than that of the lighter curve 120. For instance, the darker curve 122 can illustrate the histogram calculated with the highest probability of aliasing over a time period, such as within the past ten seconds, the past thirty heart cycles, or since the beginning of the TDI exam, to give just a few possibilities. The curve 122 is updated whenever a new histogram of greater aliasing occurrences is produced. The lighter curve 120 is updated on a more current basis in this example. For instance, the lighter curve could be the histogram with greater aliasing possibilities in the current or most recent heart cycle, or most recent five heart cycles. Another possibility is that the curve 120 is updated at peak systole, the point in the heart cycle when the highest velocities are most likely to occur. The ECG waveform 106 is used as a timing reference for display of a histogram timed to the heart cycle. In this illustration the curves 122 and 120 are informing the user that, while a probable aliasing condition was detected in the past (curve 122), the most recent data is probably free of aliasing problems (curve 120).

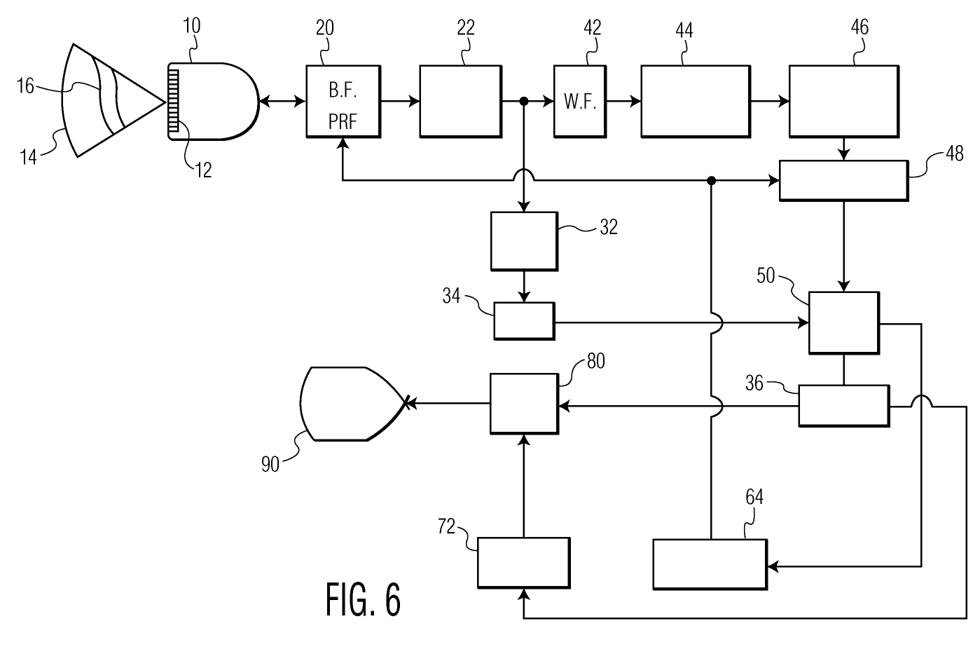

FIG. 6 illustrates another example of an ultrasound system of the present invention with automatic response to aliasing during tissue Doppler imaging. In this example, when the histogram processor 64 produces a histogram with a distribution which indicates inadequate use of the velocity scale range, or detects velocity values near or exceeding an endpoint of the color bar of the color map currently being used, the histogram processor effects either a resealing of the velocity values by the quantization processor 48 or an adjustment of the Doppler ensemble PRF. For example, when a possible aliasing condition is detected during used of a ±5 cm/sec color map, the quantization processor 48 could automatically change the range of velocities which are quantized to the range of color display, e.g., eight bits. Alternatively, histogram processor could command the beamformer controller to make an adjustment of the transmit Doppler PRF.

Other variations will readily occur to those skilled in the art. For instance the maximum positive and negative velocity values in a recent image or image set can be displayed as lines, numbers, or other symbols on or next to the color bar. The color bar can be displayed in other shapes such as a color disk. The same information can be used to advise a user to decrease the color velocity range, as when the values of the histogram are concentrated around the center or other region of the color bar.

What is claimed is:

1. An ultrasonic diagnostic imaging system for analyzing tissue motion by tissue Doppler imaging comprising:
a probe operable to acquire Doppler echo signals from moving tissue;
a Doppler processor coupled to the probe and responsive to the Doppler echo signals which acts to produce tissue motion signals;
a color mapping processor coupled to the Doppler processor for mapping the tissue motion signals to corresponding color values;
a user interface coupled to the color mapping processor for displaying an image of tissue motion in color, the range of color values employed by the color mapping processor and an indicator alerting a user to the possibility of aliasing in the displayed tissue motion.

2. The ultrasonic diagnostic imaging system of claim 1, wherein the indicator comprises a speaker which audibly alerts a user to the possibility of aliasing.

3. The ultrasonic diagnostic imaging system of claim 1, further comprising a histogram processor coupled to the color mapping processor which operates to produce a histogram of color values used in a tissue motion image,
wherein the indicator comprises a histogram display on the same display screen as the range of color values.

4. The ultrasonic diagnostic imaging system of claim 3, wherein the range of color values comprises a color bar; and
wherein the histogram display is aligned with the colors of the color bar represented by the points of the histogram.

5. The ultrasonic diagnostic imaging system of claim 4, wherein the color bar exhibits first and second velocity endpoints,
wherein the presence of histogram values in proximity to an endpoint of the color bar indicates a possibility of aliasing.

6. The ultrasonic diagnostic imaging system of claim 3, wherein the tissue motion is displayed in color at a display frame rate; and
wherein the histogram display is updated less frequently than the display frame rate.

7. The ultrasonic diagnostic imaging system of claim 6, further comprising a heart rate signal,
wherein the histogram display is updated in response to the timing of the heart rate signal.

8. The ultrasonic diagnostic imaging system of claim 6, wherein the histogram display is updated periodically based upon time.

9. The ultrasonic diagnostic imaging system of claim 6, wherein the histogram display exhibits a given characteristic,
wherein the histogram display is updated based upon the given characteristic of a current histogram in relation to that of a previously displayed histogram.

10. The ultrasonic diagnostic imaging system of claim 6, wherein the histogram processor is operable to produce a second histogram of color values used in a tissue motion image,
wherein the first and second histograms are based upon temporally different tissue motion images.

11. The ultrasonic diagnostic imaging system of claim 10, wherein the first histogram is based upon color values produced over a relatively long period of time and the second histogram is based upon color values produced over a shorter period of time.

12. The ultrasonic diagnostic imaging system of claim 1, further comprising a histogram processor coupled to the color mapping processor which operates to produce a histogram of color values used in a tissue motion image,
wherein the indicator comprises a speaker, responsive to the histogram processor, which audibly alerts a user to the possibility of aliasing.

13. The ultrasonic diagnostic imaging system of claim 1, wherein the color mapping processor is operable to map tissue motion signals to a range of color values, the range of color values having endpoints corresponding to maximum velocity limits,
wherein tissue motion signals at or in the vicinity of a maximum velocity limit are mapped to a color which is distinctly different from the colors of the range of color values.

14. The ultrasonic diagnostic imaging system of claim 1, wherein the indicator comprises a visual indicator.

15. The ultrasonic diagnostic imaging system of claim 1, wherein the visual indicator comprises a numerical indicator.

16. The ultrasonic diagnostic imaging system of claim 15, wherein the numerical indicator indicates the proportion of the range of color values used in a tissue motion image.

17. The ultrasonic diagnostic imaging system of claim 1, further comprising a velocity scale control, operable by a user, to adjust the range of color values to which tissue motion signals are mapped,
wherein the indicator alerts a user to the use of the velocity scale control.
